(19) United States
(12) Patent Application Publication
(10) Pub. No.: US 2006/0005385 A1
(43) Pub. Date: Jan. 12, 2006

(54) Method and assembly system for manufacturing an assembled camshaft

(75) Inventor: Ralf Quaas, Mannheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/174,850

(22) Filed: Jul. 5, 2005

(30) Foreign Application Priority Data
Jul. 6, 2004 (DE) 10 2004 032 587.1

(51) Int. Cl. B23P 11/02

(52) U.S. Cl. 29/888.08; 29/447

(57) ABSTRACT

A method and an assembly system for manufacturing an assembled camshaft having a metallic shaft and at least one shrunk-on cam, includes initially heating the at least one cam, threading the at least one cam onto the shaft in a predetermined position in the heated state, and subsequently shrinking the at least one cam onto the shaft due to a cooling down. The shaft is cooled down prior to thread-on of the cams so that the cams are shrunk onto the shaft due to a temperature equalization which includes heating of the shaft and cooling down of the cams. The assembly system includes multiple drums in which the shafts and the cams to be fitted are accommodated and cooled and/or heated. The shafts are cooled preferably with the aid of a cooling lance inserted into a hollow space of the shaft.

Priority is claimed to German Patent Application No. DE 10 2004 032 587.1, filed on Jul. 6, 2004, the entire disclosure of which is incorporated by reference herein.

The present invention relates to a method for manufacturing an assembled camshaft made up of a metallic shaft including shrunk-on cams. Furthermore, the present invention relates to an assembly system for carrying out this method.

### BACKGROUND

A shrink-on method for manufacturing an assembled camshaft made up of a metallic hollow shaft and multiple cams is described in DE 32 47 636 C2, which is incorporated by reference herein. The cams are heated, threaded onto the shaft using an elevated temperature with respect to the shaft, and brought into the correct position there using a positioning device. A formfitting shrink joint between the cams and the shaft is achieved due to the subsequent temperature equalization between the cams and the metallic shaft.

In order to be able to thread the cams onto the shaft and to position them there with high accuracy, the cams must be heated to a temperature which is higher than the tempering temperature of the cam material. This extreme heating results in changes in the material properties of the (already hardened) cams which have an adverse effect on the wear resistance of the cams and is therefore undesirable.

### SUMMARY OF THE INVENTION

An object of the present invention is to improve on the known shrink-on method for manufacturing an assembled camshaft in such a way that the material properties of the cams are not affected. Moreover, an assembly system is proposed which enables cost-effective and large scale-capable manufacturing of such cams.

According to the present invention, the shaft is cooled down prior to threading of the heated cams. The temperature difference, which is necessary for a non-slip fit of the cams on the shaft, is thus not generated via heating of the cams alone, but via cooling of the shaft paired with heating of the cams. The temperature to which the cams must be heated depends on the cooling temperature of the shaft and may therefore be set in a temperature range which is below the tempering temperature of the cams. In this way, a structural change of the cams may be ruled out so that the wear resistance of the cams remains unchanged during joining with the shaft.

This is particularly advantageous in commercial vehicle camshafts having brake cams which are exposed to great forces during operation. In fully hardened cams made of 100Cr6, for example, which are to be shrunk onto a hollow shaft made of St52-3, a definite temperature difference (of at least 150° C.) is necessary between the cams and the shaft in order to enable threading of the cams onto the shaft during manufacturing and to implement a high degree of bite of the cams on the shaft. If the hardened cams are heated to temperatures above 200° C., it results in significant “softening” of the cam hardening. According to the present invention, the shaft is cooled to a low temperature for threading and positioning of the cams onto the shaft, while the hardened cams, depending on the required joint clearance or intended bite, are only heated to temperatures between 150° C. and 200° C. In this way, the required joint clearance may be achieved, optimum bite of the cams on the shaft may be ensured, and structural change of the hardened cams may be effectively avoided at the same time.

If the method is used for manufacturing hollow camshafts, it is recommended to cool the shaft with the aid of a cooling lance which is inserted into the interior of the shaft.

For manufacturing the camshafts, an assembly system is used which includes rotatable drums for accommodating the shafts to be fitted, the cooling lances, and the cams. The cams are heated and the shafts are cooled down in these drums. The drums are situated with respect to one another in such a way that their rotational axes are parallel; their rotary motions are adjusted to one another in such a way that, at the time of assembly, the axis of the shaft to be fitted, the axes of the cams to be threaded onto this shaft, and the axis of the cooling lance are collinear with one another. The assembly system advantageously includes an axially displaceable counterholder with the aid of which the shaft and the cooling lance inserted into the shaft may be guided with high accuracy during axial displacement of the shaft, in particular during threading of the cams onto the shaft This counterholder may also be accommodated in a rotatable drum whose rotational axis is collinear with the rotational axis of the lance drum. This assembly system makes camshaft manufacturing in a continuous operation possible and is suitable for cost-effective large-scale production; loading, cooling down of the shaft, heating of the cams, assembly, temperature equalization, and unloading of the finished camshafts overlap in time, so that a high camshaft production rate may be achieved.

### BRIEF DESCRIPTION OF THE DRAWINGS

The present invention is subsequently explained in greater detail based on an exemplary embodiment illustrated in the drawings, in which:

FIG. 1 shows a schematic representation of a shaft including cams to be shrunk on:
FIG. 1a: with cams and shaft at the same temperature; and
FIG. 1b: with heated cams and cooled shaft;

FIG. 2 shows a schematic representation of selected process steps during manufacturing of an assembled camshaft:
FIG. 2a: insertion of a cooling lance into the shaft;
FIG. 2b: feed of a counterholder;
FIG. 2c: insertion of the cooled shaft into the pre-positioned heated cams;
FIG. 2d: temperature equalization between the cams and the shaft; and
FIG. 2e: unloading of the finished camshaft:

FIG. 3 shows a detailed representation of a contact area between a cooling lance and a counterholder (area III in FIG. 2b);

FIG. 4 shows a schematic top view on an assembly system for manufacturing composite camshafts;

FIG. 5 shows schematic sectional views of the assembly system of FIG. 4 according to selected sections in FIG. 4:
FIG. 5a: section Va-Va (lance drum);
FIG. 5b: section Vb-Vb (axis drum);
FIG. 5c: section Vc-Vc (cam drum); and
FIG. 5d: section Vd-Vd (counterholder drum); and

FIG. 6 shows a detailed representation of two cam support discs according to detail VI in FIG. 4.

### DETAILED DESCRIPTION

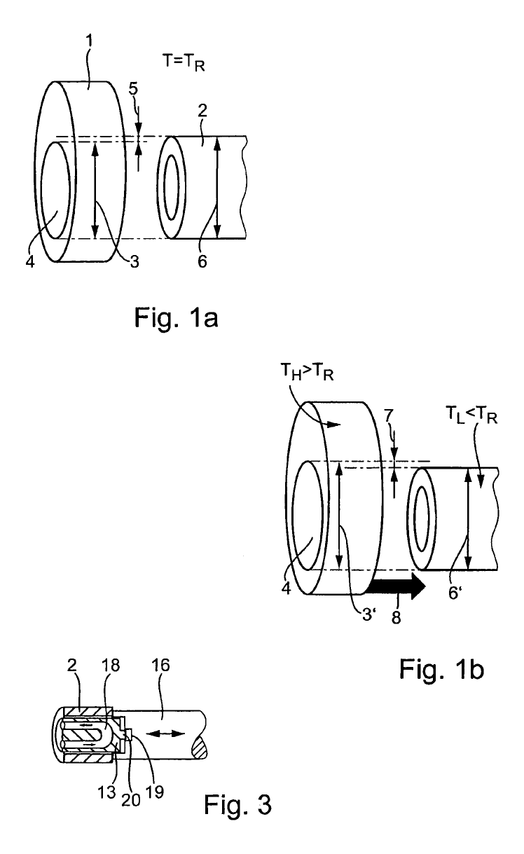

FIG. 1 shows a schematic representation of a hardened cam 1 which is to be shrunk onto a hollow shaft 2. In order to ensure a firm hold of cam 1 on hollow shaft 2, internal diameter 3 of cam opening 4 at room temperature T_{R} is smaller then external diameter 6 of shaft 2 by what is called a “bite” 5. If shaft 2 is cooled down to a temperature T_{L}<T_{R}, its external diameter is reduced to a value 6′; if cam 1 is heated to a temperature T_{H}>T_{R}, internal diameter 3′ of cam opening 4 increases with the effect that internal diameter 3′ of cam opening 4 is larger than external diameter 6′ of shaft 2 by what is called a “joint clearance” 7 so that heated cam 1 may be slid onto cooled shaft 2 (arrow 8 in FIG. 1b). During cooling down of cam 1 and heating of shaft 2, cam 1 is shrunk onto shaft 2 along with the temperature equalization, “bite” 5 preventing cam 1 from slipping on shaft 2.

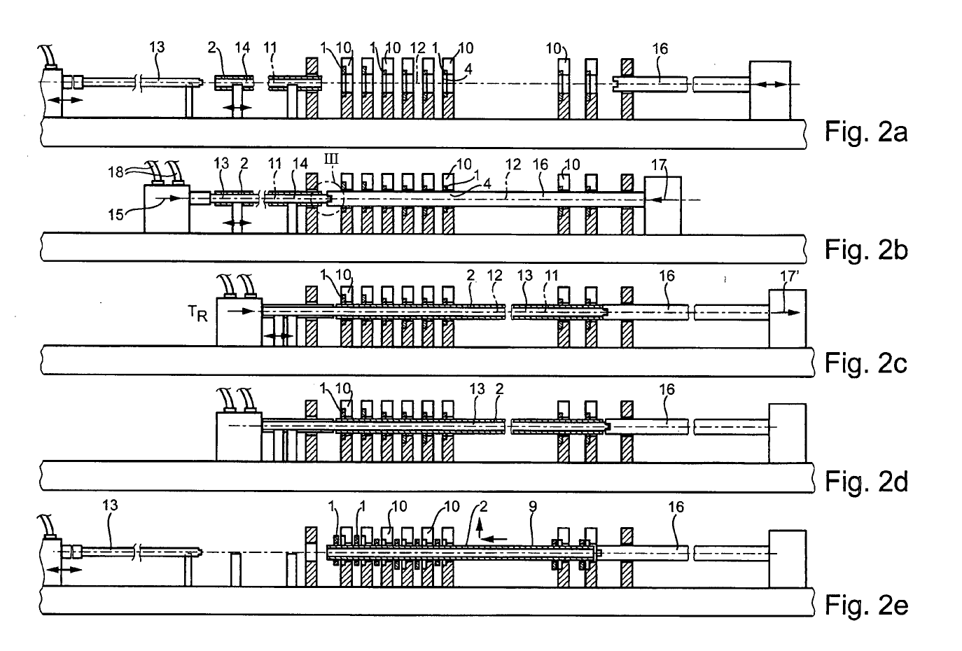

FIGS. 2a through 2e show a schematic representation of the process steps involved in carrying out the shrink-on method according to the present invention. An assembled camshaft 9 is manufactured from a hollow shaft 2 made of St52-3 and multiple cams made of 100Cr6. Cams 1 are inserted into cam holders 10 with the aid of which cams 1 are held in the intended relative position and relative angular position with respect to one another and heated in these cam holders. Hollow shaft 2 is aligned with respect to cam holders 10 in such a way that shaft axis 11 is collinear with axes 12 of openings 4 of cams 1 inserted into cam holders 10 (see FIG. 2a). A cooling lance 13, cooled by a fluid coolant 18, is inserted in this position into an interior 14 of hollow shaft 2 (arrow 15 in FIG. 2b), thereby cooling down hollow shaft 2 which results in shrinking of shaft 2. A counterholder 16 is simultaneously pushed through cam openings 4 from the opposite side of cam holders 10 (arrow 17 in FIG. 2b). As is apparent from the detailed representation of FIG. 3, counterholder 16 is provided at its end with a location opening 19 which engages in a formfitting manner a projection 20 on the end of cooling lance 13. Highly accurate positioning of the end of counterholder 16 vis-a-vis the end of cooling lance 20 is hereby achieved, which in turn enables a highly accurate alignment of cooling lance 13 and counterholder 16. Both interlocking ends 19, 20 may be designed in a different way.

When shaft 2 is sufficiently cooled down, cooled shaft 2 is inserted into cam holders 10 which contain heated cams 1 (arrow 15 in FIG. 2c). Counterholder 16 retreats in the process (arrow 17′) thereby ensuring that shaft axis 11 is accurately aligned vis-a-vis cam axis 12, so that cooled shaft 2 does not come into contact with heated cams 1. When shaft 2 has reached the intended position, cams 1 are shrunk onto shaft 2; this is initially carried out slowly (based on the cooling down of cams 1 by ambient room temperature T_{R}) and subsequently faster (based on the temperature equalization between shaft 2 and cams 1 (see FIG. 2d)). Cooling lance 13 is pulled out of shaft 2 in the following unloading phase and the completely fitted camshaft is removed from cam holders 10. (FIG. 2e).

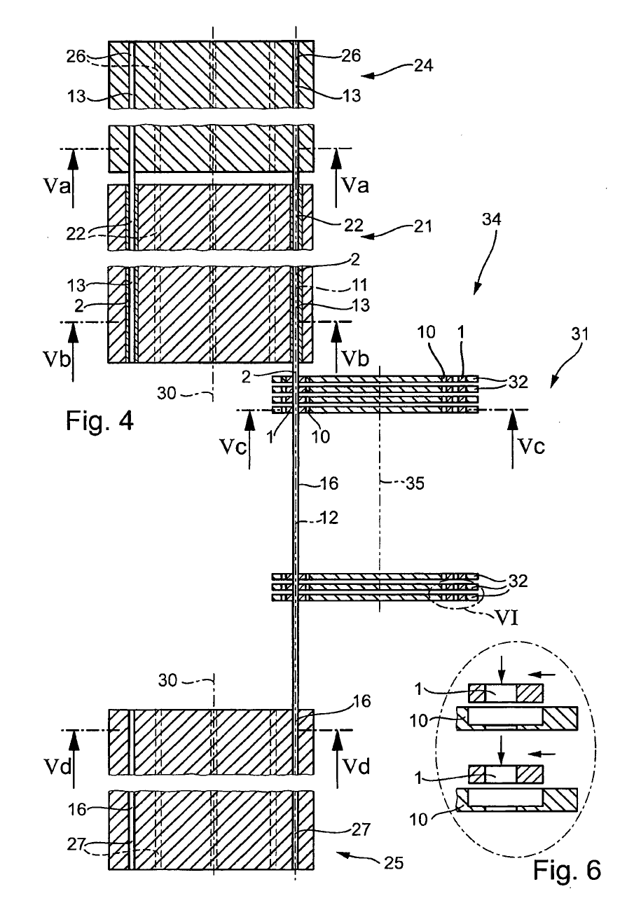

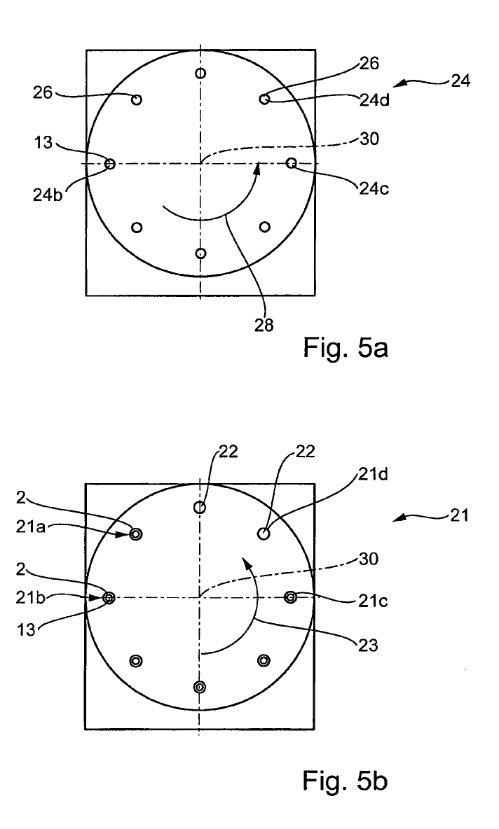

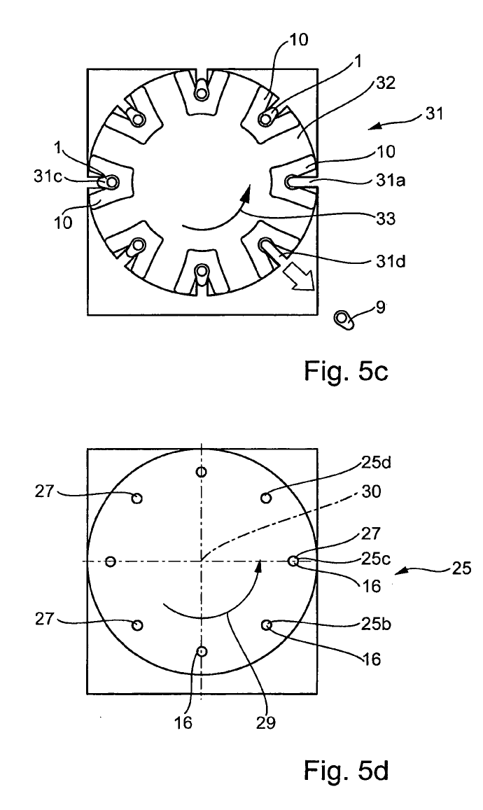

In order to ensure economical large-scale production of composite camshafts with the aid of the method according to the present invention, shafts 2 to be fitted and cams 1 to be fitted are kept in rotatable magazines (“drums”) in which they are supplied to the place of assembly. Such an assembly system 34 is shown in FIG. 4 in a schematic view and in the sectional views of FIGS. 5a through 5d using an example of drums for simultaneously accommodating eight shafts 2:

A first drum 21 (axis drum) contains eight tubes 22 for accommodating hollow shafts 2 and is used for accommodating and supplying hollow shafts 2 to the place of assembly which is indicated in FIG. 4 by shaft axis 11 and cam axis 12. Hollow shafts 2 are inserted into axis drum 21 in an angular position 21a (see the sectional view in FIG. 5b). After further rotation of the axis drum (arrow direction 23), cooling lance 13 is inserted into interior 14 of hollow shaft 2 in angular position 21b and remains in hollow shaft 2 for the subsequent cooling phase (during which the drum rotates further to angular position 21c). In angular position 21c, the assembly position is reached in which shaft 2 together with cooling lance 13 is pushed out of axis drum 21 through cams 1 (see FIGS. 2c and 2d). Temperature equalization subsequently takes place between shaft 2 and cams 1 until cooling lance 13 is retracted from interior space 14 of shaft 2 (see FIG. 2e). Tube 22 may then be provided (in angular position 21a) with a new shaft 2.

A lance drum 24 is shown in the sectional view of FIG. 5a and a counterholder drum 25 is shown in the sectional view of FIG. 5d. Each of these drums 24, 25 contains eight tubes 26, 27 for accommodating cooling lances 13 and counterholders 16 and rotates synchronously with axis drum 21 (arrow directions 28, 29) around a common axis 30, 30′. In an angular position 24b, which corresponds to angular position 21b of axis drum 21, cooling lance 13 is inserted into hollow shaft 2 which is held in axis drum 21 (see FIG. 2a). In the assembly position, cooling lance 13 together with shaft 2 is pushed through cams 1 and subsequently retracted from the finished camshaft 9. In an angular position 25b of counterholder drum 25 situated in front of assembly position 25c, counterholder 16 is extended and docked on tip 20 of cooling lance 13 (see FIG. 2b). Counterholder 16 is retracted after completed assembly in assembly position 25c.

As is apparent from FIGS. 4 and 5c, a cam drum 31 is situated axially offset vis-a-vis axis drum 21, the cam drum containing multiple cam holder discs 32 each having eight cam holders 10 for accommodating cams 1. Cam drum 31 is rotatable around a rotational axis 35. The number of cam holder discs 32 corresponds to the number of cams 1 which are to be assembled on shaft 2. Rotation 33 of cam drum 31 is synchronized with rotation 23 of axis drum 21. This means that at the time of assembly (when a given shaft 2 is situated in assembly position 21c of axis drum 21 and associated cams 1 are situated in an assembly position 31c of cam drum 31) axes 12 of cams 1 are collinear with shaft axis 11. In a loading position 31a opposite assembly position 31c, cams 1 are inserted into cam holders 10 of cam holder discs 32 in a predetermined alignment. Cams 1 fixed in cam holders 10 are heated during further rotation of cam drum 31. In assembly position 31c, shaft 2 is inserted through cams 1 into cam drum 31 (see FIGS. 2c and 2d). During subsequent further rotation of cam drum 31, the above-described temperature equalization takes place between cams 1 and shaft 2 via which cams 1 are shrunk onto shaft 2. In unloading position 31d of cam drum 31, completely fitted camshaft 9 is removed from cam drum 31.

An assembly system 34 having eight tubes 22, 26, 27 and eight cam holders 10 is shown in the exemplary embodiment of FIGS. 4 and 5; the assembly system may, of course, also have a greater or smaller number of tubes and cam holders.

In addition to or instead of cams 1, other elements, e.g., bearing rings, may also be mounted on a hollow shaft using the method according to the present invention.

In addition to the described application on hollow camshafts 2, the method may also be used mounting cams 1 on solid shafts. In this case, however, the shaft cannot be cooled with the aid of a cooling lance 13 which is inserted into interior 14 of shaft 2.

What is claimed is:

1. A method for manufacturing an assembled camshaft that includes a metallic shaft having at least one cam, the method comprising:
heating the at least one cam to a heated state;
cooling the shaft to a cooled state;
threading the at least one cam in the heated state onto the shaft in the cooled state to a predetermined position;
shrinking the at least one cam relative to the shaft, wherein the shrinking includes heating the shaft and cooling the cam.

2. The method as recited in claim 1, wherein the cooling of the shaft includes is performed to a temperature between 0° C. and −120° C. and wherein the heating of the cam is performed to a temperature between 150° C. and 200° C.

3. The method as recited in claim 1, wherein the cooling of the shaft includes inserting a cooling lance into an interior of the shaft and flowing a cooling medium through the cooling lance.

4. An assembly system for assembling a camshaft that include a metallic shaft and at least one cam, the assembly system comprising:
a rotatable axis drum for accommodating the shaft;
a rotatable lance drum for accommodating an axially displaceable cooling lance; and
a rotatable cam drum for accommodating the at least one cam, wherein a rotational axis of the axis drum and a rotational axis of the lance drum are collinear and parallel to a rotational axis of the cam drum, and wherein rotary motions of the axis drum, the lance drum, and the cam drum are adjustable so that the rotational axes of the axis drum, the lance drum, and the cam drum are collinear at a time of assembly.

5. The assembly system as recited in claim 4, further comprising an axially displaceable counterholder having a first securing element disposed at one end, the securing element configured to engage a second securing element disposed at an end of the cooling lance.

6. The assembly system as recited in claim 5, further comprising a rotatable counterholder drum for accommodating the counterholder and having a rotational axis collinear with a rotational axis of the lance drum.
